(19) United States
(12) Patent Application Publication
(10) Pub. No.: US 2019/0140823 A1
(43) Pub. Date: May 9, 2019

(54) Method for Detecting Encrypted Content, and Device

(71) Applicant: Huawei Technologies Co., Ltd., Shenzhen (CN)

(72) Inventors: Yuming Xie, Nanjing (CN); Bo Zhang, Nanjing (CN); Zhigang Huang, Nanjing (CN); Jianjie You, Shenzhen (CN); Yang Wang, Shenzhen (CN)

(21) Appl. No.: 16/222,152

(22) Filed: Dec. 17, 2018

Related U.S. Application Data
(63) Continuation of application No. PCT/CN2017/087989, filed on Jun. 13, 2017.

(30) Foreign Application Priority Data
Jun. 15, 2016 (CN) 201610428384.6

(51) Int. Cl. H04L 9/08; H04L 29/06

(52) U.S. Cl. CPC H04L 9/083; H04L 9/0869; H04L 63/0485; H04L 63/166

(57) ABSTRACT

A method for detecting encrypted content and a device, where the method includes receiving, by a middlebox network device using a first secure channel, key information of a Transport Layer Security (TLS) secure channel from a key manager, obtaining, by the middlebox network device based on 5-tuple information of the TLS secure channel, encrypted application data transmitted over the TLS secure channel, decrypting, by the middlebox network device, the encrypted application data using a session key, and detecting decrypted content. Hence, the middlebox network device decrypts the encrypted application data, and detects decrypted application data. In this way, detection of encrypted content does not rely on a TLS proxy server, and detection complexity and detection costs can be reduced.

### CROSS-REFERENCE TO RELATED APPLICATIONS

This application is a continuation of International Patent Application No. PCT/CN2017/087989 filed on Jun. 13, 2017, which claims priority to Chinese Patent Application No. 201610428384.6 filed on Jun. 15, 2016. The disclosures of the aforementioned applications are hereby incorporated by reference in their entireties.

### TECHNICAL FIELD

The present disclosure relates to the communications field, and in particular, to a method for detecting encrypted content, a key manager, a middlebox network device, and a server.

### BACKGROUND

With wide application of cloud technologies, more enterprises deploy cloud services in a data center network (DCN). To ensure privacy security of user information, the DCN provides encrypted access to a cloud service based on the Transport Layer Security (TLS). In addition, to ensure service security, a security resource pool is deployed at an egress of the DCN, and the security resource pool includes a firewall (FW), an intrusion prevention system (IPS), distributed denial of service (DDoS) prevention, virus detection, network behavior monitoring, and the like.

The TLS exposes a new covert threat carrier to a hacker while providing confidentiality and data integrity between two communications application programs. If a virus, a Trojan horse, malware, or the like is hidden in encrypted content, and the encrypted content is not detected using a network security device (usually referred to as a middlebox network device) such as an FW, an intrusion detection system (IDS), or an IPS, losses are caused to enterprises and individuals. Therefore, how the network security device such as the FW or the IPS detects TLS encrypted content used for accessing a DCN service becomes a critical issue.

In other approaches, a method shown in FIG. 1 is used to detect TLS encrypted content. As shown in FIG. 1, a TLS secure channel 1 is established between a client and a TLS proxy server, and a TLS secure channel 2 is established between the TLS proxy server and a server. That the client sends an encrypted packet to the server is used as an example. The TLS proxy server decrypts an encrypted packet received using the TLS secure channel 1, and then transmits a decrypted packet to a middlebox network device for plaintext content detection. The middlebox network device returns an optimized packet to the TLS proxy server, and then the TLS proxy server encrypts the optimized packet, and sends an encrypted packet to the server using the TLS secure channel 2. Such a solution using two independent TLS secure channels needs to rely on the TLS proxy server, and therefore high detection complexity and relatively high costs are caused.

### SUMMARY

Embodiments of the present disclosure provide a method for detecting encrypted content, a key manager, a middlebox network device, a server, a client, and a software-defined networking (SDN) controller to reduce detection complexity and detection costs.

According to a first aspect, a method for detecting encrypted content is provided, where the method is applied to a communications network, the communications network includes a middlebox network device, a key manager, and a server, the middlebox network device is located on a TLS secure channel established between a client and the server, and the method includes obtaining, by the key manager, key information of the TLS secure channel, and sending, by the key manager, the key information to the middlebox network device using a first secure channel such that the middlebox network device decrypts, using a session key corresponding to the key information, encrypted application data transmitted over the TLS secure channel, and detects decrypted application data, where the encrypted application data is generated by the client or the server by encrypting application data based on the session key, and the first secure channel is a secure channel established between the key manager and the middlebox network device.

In the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

With reference to the first aspect, in a first possible implementation of the first aspect, before obtaining, by the key manager, key information of the TLS secure channel, the method further includes receiving, by the key manager, a first key request message sent by the middlebox network device using the first secure channel, where the first key request message includes 5-tuple information of the TLS secure channel, the first key request message is used to request the key information, and the 5-tuple information includes an Internet Protocol (IP) address of the client, a port number of the client, an IP address of the server, a port number of the server, and a transport layer protocol, and obtaining, by the key manager, key information of the TLS secure channel includes obtaining, by the key manager, the key information based on the 5-tuple information.

With reference to the first possible implementation of the first aspect, in a second possible implementation of the first aspect, obtaining, by the key manager, the key information based on the 5-tuple information includes sending, by the key manager, a second key request message to the server using a second secure channel, where the second key request message includes the 5-tuple information, and the second secure channel is a secure channel established between the key manager and the server, and receiving, by the key manager, the key information sent by the server based on the second key request message.

With reference to the first aspect, in a third possible implementation of the first aspect, obtaining, by the key manager, key information of the TLS secure channel includes receiving, by the key manager using a second secure channel, session information sent by the server, where the session information includes 5-tuple information of the TLS secure channel and the key information, the 5-tuple information includes an IP address of the client, a port number of the client, an IP address of the server, a port number of the server, and a transport layer protocol, and the second secure channel is a secure channel established between the key manager and the server, and obtaining, by the key manager, the key information in the session information, before sending, by the key manager, the key information to the middlebox network device using a first secure channel, the method further includes determining, by the key manager, the middlebox network device that is on the TLS secure channel identified by the 5-tuple information, and the method further includes sending, by the key manager, the 5-tuple information to the middlebox network device.

With reference to the third possible implementation of the first aspect, in a fourth possible implementation of the first aspect, the communications network further includes a SDN controller, where the key manager is connected to the SDN controller, and the SDN controller is connected to the middlebox network device, and determining, by the key manager, the middlebox network device based on the 5-tuple information includes sending, by the key manager, a device request message to the SDN controller, where the device request message includes the 5-tuple information, and the device request message is used to request device information of the middlebox network device that is on the TLS secure channel identified by the 5-tuple information, and receiving, by the key manager, the device information sent by the SDN controller based on the device request message.

With reference to any one of the first aspect and the possible implementations of the first aspect, in a fifth possible implementation of the first aspect, the key information includes a first random number, a second random number, a pre-master key, and a pseudo-random function, the first random number and the pre-master key are random numbers generated by the client, the second random number is a random number generated by the server, and the pseudo-random function is used to generate the session key based on the first random number, the second random number, and the pre-master key.

With reference to any one of the first aspect and the second to the fourth possible implementations of the first aspect, in a sixth possible implementation of the first aspect, the key information includes the session key.

With reference to the first aspect, in a seventh possible implementation of the first aspect, the key information includes the session key, and obtaining, by the key manager, key information of the TLS secure channel includes generating, by the key manager, the session key based on a first random number, a second random number, a pre-master key, and a pseudo-random function that are received from the server, where the first random number and the pre-master key are random numbers generated by the client, the second random number is a random number generated by the server, and the pseudo-random function is used to generate the session key based on the first random number, the second random number, and the pre-master key.

With reference to any one of the first aspect and the possible implementations of the first aspect, in an eighth possible implementation of the first aspect, before sending, by the key manager, the key information to the middlebox network device using a first secure channel, the method further includes establishing the first secure channel between the key manager and the middlebox network device.

According to a second aspect, a method for detecting encrypted content is provided, where the method is applied to a communications network, the communications network includes a middlebox network device, a key manager, and a server, the middlebox network device is located on a TLS secure channel established between a client and the server, and the method includes receiving, by the middlebox network device using a first secure channel, key information that is of the TLS secure channel and that is sent by the key manager, where the first secure channel is a secure channel established between the middlebox network device and the key manager, obtaining, by the middlebox network device based on 5-tuple information of the TLS secure channel, encrypted application data transmitted over the TLS secure channel, where the 5-tuple information includes an IP address of the client, a port number of the client, an IP address of the server, a port number of the server, and a transport layer protocol, and the encrypted application data is generated by the client or the server by encrypting application data based on a session key corresponding to the key information, and decrypting, by the middlebox network device, the encrypted application data using the session key, and detecting decrypted application data.

In the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

With reference to the second aspect, in a first possible implementation of the second aspect, the key information includes a first random number, a second random number, a pre-master key, and a pseudo-random function, the first random number and the pre-master key are random numbers generated by the client, the second random number is a random number generated by the server, and the pseudo-random function is used to generate the session key based on the first random number, the second random number, and the pre-master key, and before decrypting, by the middlebox network device, the encrypted application data using the session key, the method further includes generating, by the middlebox network device, the session key based on the first random number, the second random number, the pre-master key, and the pseudo-random function, for example, using the first random number, the second random number, and the pre-master key as independent variables of the pseudo-random function, and computing the session key using the pseudo-random function.

With reference to the second aspect or the first possible implementation of the second aspect, in a second possible implementation of the second aspect, the key information includes the session key.

With reference to any one of the second aspect and the possible implementations of the second aspect, in a third possible implementation of the second aspect, before receiving, by the middlebox network device using a first secure channel, key information that is of the TLS secure channel and that is sent by the key manager, the method further includes sending, by the middlebox network device, a key request message to the key manager using the first secure channel, where the key request message includes the 5-tuple information, and the key request message is used to request the key information, and receiving, by the middlebox network device using a first secure channel, key information that is of the TLS secure channel and that is sent by the key manager includes receiving, by the middlebox network device using the first secure channel, the key information sent by the key manager based on the key request message.

With reference to any one of the second aspect and the possible implementations of the second aspect, in a fourth possible implementation of the second aspect, before obtaining, by the middlebox network device based on 5-tuple information of the TLS secure channel, encrypted application data transmitted over the TLS secure channel, the method further includes receiving, by the middlebox network device using the first secure channel, the 5-tuple information sent by the key manager.

According to a third aspect, a method for detecting encrypted content is provided, where the method is applied to a communications network, the communications network includes a middlebox network device, a key manager, and a server, the middlebox network device is located on a TLS secure channel established between a client and the server, and the method includes determining, by the server, key information of the TLS secure channel, and sending, by the server, the key information to the key manager using a second secure channel such that the key manager sends the key information to the middlebox network device using the first secure channel, and the middlebox network device decrypts, using a session key corresponding to the key information, encrypted application data transmitted over the TLS secure channel, and detects decrypted application data, where the encrypted application data is generated by the client or the server by encrypting application data based on the session key, the first secure channel is a secure channel established between the key manager and the middlebox network device, and the second secure channel is a secure channel established between the key manager and the server.

In the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

With reference to the third aspect, in a first possible implementation of the third aspect, before sending, by the server, the key information to the key manager using a second secure channel, the method further includes sending, by the server, a detection query message to the client using the TLS secure channel, where the detection query message is used to determine whether the client allows the middlebox network device to detect encrypted content of the encrypted application data, and receiving, by the server, a detection allowed message that is fed back on the detection query message and that is sent by the client, where the detection allowed message is used to indicate that the client allows the middlebox network device to detect the encrypted content of the encrypted application data.

When the client allows the middlebox network device to detect encrypted content transmitted between the client and the server, the encrypted content is detected such that a security risk can be reduced.

With reference to the third aspect or the first possible implementation of the third aspect, in a second possible implementation of the third aspect, before determining, by the server, key information of the TLS secure channel, the method further includes receiving, by the server, a key request message sent by the key manager using the second secure channel, where the key request message includes 5-tuple information of the TLS secure channel, the key request message is used to request the key information, and the 5-tuple information includes an IP address of the client, a port number of the client, an IP address of the server, a port number of the server, and a transport layer protocol, and determining, by the server, key information includes determining, by the server based on the 5-tuple information, the key information of the TLS secure channel identified by the 5-tuple information.

With reference to the third aspect or the first possible implementation of the third aspect, in a third possible implementation of the third aspect, the method further includes determining, by the server, 5-tuple information of the TLS secure channel, where the 5-tuple information includes an IP address of the client, a port number of the client, an IP address of the server, a port number of the server, and a transport layer protocol, and sending, by the server, the 5-tuple information to the key manager.

According to a fourth aspect, a method for detecting encrypted content is provided, where the method is applied to a communications network, the communications network includes a middlebox network device, a key manager, and a server, the middlebox network device is located on a TLS secure channel established between a client and the server, and the method includes receiving, by the client, a detection query message sent by the server using the TLS secure channel, where the detection query message is used to determine whether the client allows the middlebox network device to detect encrypted content of encrypted application data, and the encrypted application data is generated by the client or the server by encrypting application data based on a session key of the TLS secure channel, and when the client allows the middlebox network device to detect the encrypted content of the encrypted application data, sending a detection allowed message to the server using the TLS secure channel.

When the client allows the middlebox network device to detect encrypted content transmitted between the client and the server, the encrypted content is detected such that a security risk can be reduced.

According to a fifth aspect, a method for detecting encrypted content is provided, where the method is applied to a communications network, the communications network includes a middlebox network device, a key manager, an SDN controller, and a server, the middlebox network device is located on a TLS secure channel established between a client and the server, the key manager is connected to the SDN controller, the SDN controller is connected to the middlebox network device, and the method includes receiving, by the SDN controller, a device request message sent by the key manager, where the device request message includes 5-tuple information of the TLS secure channel, and the 5-tuple information includes an IP address of the client, a port number of the client, an IP address of the server, a port number of the server, and a transport layer protocol, determining, by the SDN controller based on the device request message, device information of the middlebox network device that is on the TLS secure channel identified by the 5-tuple information, and sending, by the SDN controller, the device information to the key manager such that the key manager sends the 5-tuple information and key information that is of the TLS secure channel to the middlebox network device based on the device information of the middlebox network device using a first secure channel, and the middlebox network device obtains, based on the 5-tuple information, encrypted application data transmitted between the client and the server using the TLS secure channel, decrypts the encrypted application data using a session key corresponding to the key information, and detects decrypted application data, where the encrypted application data is generated by the client or the server by encrypting application data based on the session key, and the first secure channel is a secure channel established between the middlebox network device and the key manager.

In the method for detecting encrypted content in this embodiment of the present disclosure, the middlebox network device determined by the SDN controller decrypts the encrypted application data, and detects the decrypted application data. In this way, detection of encrypted content does not rely on a TLS proxy server, and detection complexity and detection costs can be reduced.

According to a sixth aspect, a key manager is provided, and is configured to perform the method according to any one of the first aspect and the possible implementations of the first aspect. Further, the key manager includes units configured to perform the method according to any one of the first aspect and the possible implementations of the first aspect.

According to a seventh aspect, a middlebox network device is provided, and is configured to perform the method according to any one of the second aspect and the possible implementations of the second aspect. Further, the middlebox network device includes units configured to perform the method according to any one of the second aspect and the possible implementations of the second aspect.

According to an eighth aspect, a server is provided, and is configured to perform the method according to any one of the third aspect and the possible implementations of the third aspect. Further, the server includes units configured to perform the method according to any one of the third aspect and the possible implementations of the third aspect.

According to a ninth aspect, a client is provided, and is configured to perform the method according to any one of the fourth aspect and the possible implementations of the fourth aspect. Further, the client includes units configured to perform the method according to any one of the fourth aspect and the possible implementations of the fourth aspect.

According to a tenth aspect, an SDN controller is provided, and is configured to perform the method according to any one of the fifth aspect and the possible implementations of the fifth aspect. Further, the SDN controller includes units configured to perform the method according to any one of the fifth aspect and the possible implementations of the fifth aspect.

According to an eleventh aspect, a key manager is provided, and the key manager includes a receiver, a transmitter, a processor, a memory, and a bus system. The receiver, the transmitter, the processor, and the memory are connected using the bus system. The memory is configured to store an instruction. The processor is configured to execute the instruction stored in the memory, to control the receiver to receive a signal and control the transmitter to send a signal. When the processor executes the instruction stored in the memory, the processor performs the method according to any one of the first aspect and the possible implementations of the first aspect.

According to a twelfth aspect, a middlebox network device is provided, and the middlebox network device includes a receiver, a transmitter, a processor, a memory, and a bus system. The receiver, the transmitter, the processor, and the memory are connected using the bus system. The memory is configured to store an instruction. The processor is configured to execute the instruction stored in the memory to control the receiver to receive a signal and control the transmitter to send a signal. When the processor executes the instruction stored in the memory, the processor performs the method according to any one of the second aspect and the possible implementations of the second aspect.

According to a thirteenth aspect, a server is provided, and the server includes a receiver, a transmitter, a processor, a memory, and a bus system. The receiver, the transmitter, the processor, and the memory are connected using the bus system. The memory is configured to store an instruction. The processor is configured to execute the instruction stored in the memory, to control the receiver to receive a signal and control the transmitter to send a signal. When the processor executes the instruction stored in the memory, the processor performs the method according to any one of the third aspect and the possible implementations of the third aspect.

According to a fourteenth aspect, a client is provided, and the client includes a receiver, a transmitter, a processor, a memory, and a bus system. The receiver, the transmitter, the processor, and the memory are connected using the bus system. The memory is configured to store an instruction. The processor is configured to execute the instruction stored in the memory, to control the receiver to receive a signal and control the transmitter to send a signal. When the processor executes the instruction stored in the memory, the processor performs the method according to any one of the fourth aspect and the possible implementations of the fourth aspect.

According to a fifteenth aspect, an SDN controller is provided, and the SDN controller includes a receiver, a transmitter, a processor, a memory, and a bus system. The receiver, the transmitter, the processor, and the memory are connected using the bus system. The memory is configured to store an instruction. The processor is configured to execute the instruction stored in the memory to control the receiver to receive a signal and control the transmitter to send a signal. When the processor executes the instruction stored in the memory, the processor performs the method according to any one of the fifth aspect and the possible implementations of the fifth aspect.

According to a sixteenth aspect, this application provides a computer readable medium configured to store a computer program, and the computer program includes an instruction used to perform the method according to any one of the first aspect and the possible implementations of the first aspect.

According to a seventeenth aspect, this application provides a computer readable medium configured to store a computer program, and the computer program includes an instruction used to perform the method according to any one of the second aspect and the possible implementations of the second aspect.

According to an eighteenth aspect, this application provides a computer readable medium configured to store a computer program, and the computer program includes an instruction used to perform the method according to any one of the third aspect and the possible implementations of the third aspect.

According to a nineteenth aspect, this application provides a computer readable medium configured to store a computer program, and the computer program includes an instruction used to perform the method according to any one of the fourth aspect and the possible implementations of the fourth aspect.

According to a twentieth aspect, this application provides a computer readable medium configured to store a computer program, and the computer program includes an instruction used to perform the method according to any one of the fifth aspect and the possible implementations of the fifth aspect.

### BRIEF DESCRIPTION OF DRAWINGS

To describe the technical solutions in some of the embodiments of the present disclosure more clearly, the following briefly describes the accompanying drawings describing some of the embodiments of the present disclosure. The accompanying drawings in the following description show merely some embodiments of the present disclosure, and a person of ordinary skill in the art may still derive other drawings from these accompanying drawings without creative efforts.

FIG. 1 shows a method for detecting encrypted content;

FIG. 2 is a schematic flowchart of a procedure of a TLS handshake phase;

FIG. 3 is a schematic block diagram of a system architecture according to an embodiment of the present disclosure;

FIG. 4 is a schematic flowchart of a method for detecting encrypted content according to an embodiment of the present disclosure;

FIG. 5 is a schematic flowchart of a method for detecting encrypted content according to an embodiment of the present disclosure;

FIG. 6 is a schematic flowchart of a method for detecting encrypted content according to another embodiment of the present disclosure;

FIG. 7 is a schematic block diagram of a key manager according to an embodiment of the present disclosure;

FIG. 8 is a schematic block diagram of a middlebox network device according to an embodiment of the present disclosure;

FIG. 9 is a schematic block diagram of a server according to an embodiment of the present disclosure;

FIG. 10 is a schematic structural diagram of a key manager according to an embodiment of the present disclosure;

FIG. 11 is a schematic structural diagram of a middlebox network device according to an embodiment of the present disclosure; and

FIG. 12 is a schematic structural diagram of a server according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

The TLS is used to provide confidentiality and data integrity between two communications application programs. A basic procedure of the TLS protocol includes the following.

(1) A client requests a public key from a server, and verifies the public key;

(2) The client negotiates with the server to generate a “session key” (the “session key” is also referred to as a “master key”); and

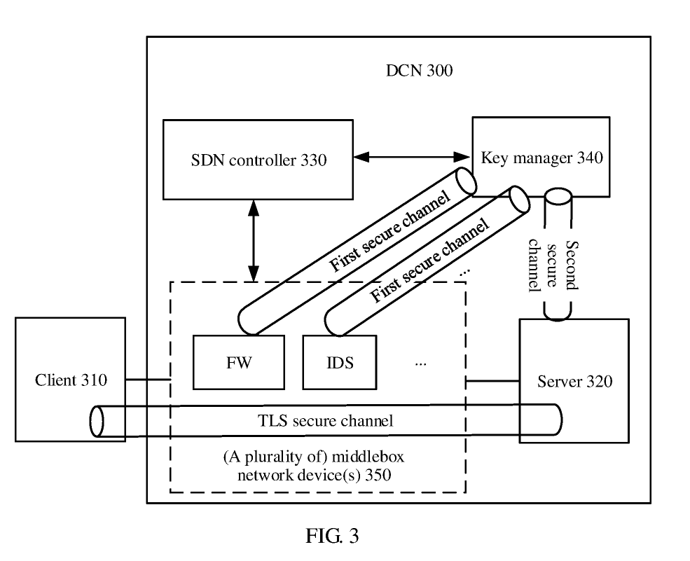

(3) The client and the server perform encrypted communication using the “session key”. The first two steps of the foregoing procedure are referred to as a “handshake phase”. FIG. 2 shows a procedure of a handshake phase between two communications application programs, the client and the server.

Step 201. The client sends a client handshake (client_hello) message to the server to start a TLS session.

First, the client (usually a browser) sends a request for encrypted communication to the server. The request is referred to as client_hello. In this step, the client mainly provides the following information for the server.

(1) A supported protocol version, for example, TLS version 1.0;

(2) A random number generated by the client and used later for generating a “session key”, where for ease of description, the random number generated by the client is referred to as a “first random number” in the following descriptions;

(3) A supported encryption method, for example, RSA public key encryption; and

(4) A supported compression method.

Step 202. The server sends a server handshake (server_hello) message to the client.

After receiving the client handshake message, the server sends the server handshake message to the client. The server handshake message is referred to as server_hello. The server handshake message mainly includes the following content.

(1) An encrypted communication protocol version determined to be used, for example, TLS version 1.0, where if a version supported by the browser is inconsistent with that supported by the server, the server terminates encrypted communication;

(2) A random number generated by the server and used later for generating a “session key”, where for ease of description, the random number generated by the server is referred to as a “second random number” in the following descriptions;

(3) An encryption method determined to be used, for example, RSA public key encryption; and

(4) A determined compression method.

Step 203. The server sends a digital certificate to the client.

The digital certificate of the server includes a public key of the server. After receiving the digital certificate sent by the server, the client authenticates the digital certificate. If authentication succeeds, the client obtains the public key of the server.

Step 204. The server sends a server handshake offline (server_hello_done) message to the client.

The server handshake offline message indicates that the server_hello message has been sent.

Step 205. The client sends a key exchange (client_key_exchange) message to the server.

The key exchange message is encrypted using the public key of the server. The key exchange message includes a random number generated by the client. The random number is a third random number in the handshake phase, and is referred to as a “pre-master key”. With the pre-master key, the client and the server each have three random numbers. Then the client and the server use the three random numbers as three independent variables of a pseudo-random function, and can separately generate a same “session key” used for a current session.

Step 206. The client sends a client finished message to the server.

The client finished message includes hash values of all content sent in steps 201 to 205, for verification by the server.

Step 207. The server sends a server finished message to the client.

After receiving the third random number of the client, to be specific, the pre-master key, the server generates, through computation, the “session key” used for the current session. Then, the server sends the server finished message to the client. The server finished message includes hash hash values of all content sent in steps 201 to 206, for verification by the client. At this point, the entire handshake phase ends.

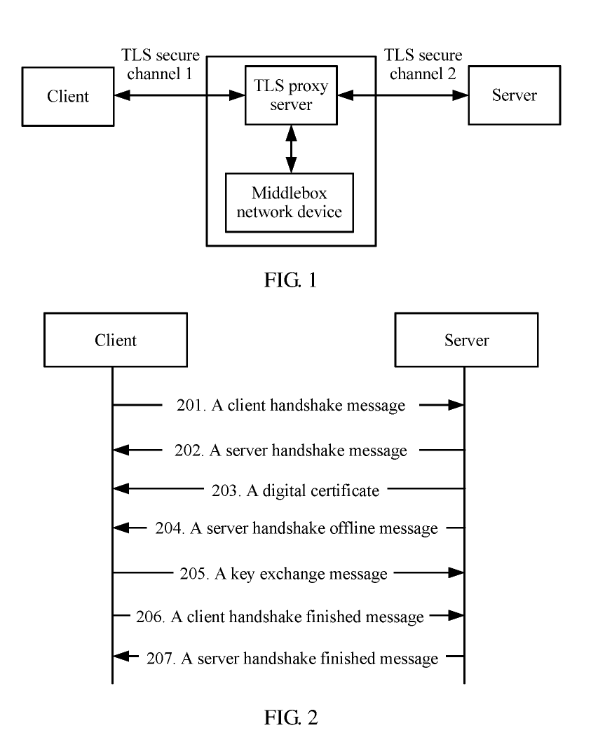

After the handshake phase is completed, a TLS secure channel is successfully established, and the client and the server can transmit application data to each other over the TLS secure channel, to be specific, the client and the server perform encrypted communication. When one of the client and the server encrypts to-be-transmitted content using the “session key”, the other may decrypt received encrypted content using the session key. During encrypted communication between the client and the server, because a virus, a Trojan horse, malware, and the like may be hidden in the encrypted content, TLS encrypted content needs to be detected. The solution shown in FIG. 1 and used in the other approaches needs to rely on a TLS proxy server, and therefore problems of high detection complexity and relatively high costs are caused.

To resolve the problems, an embodiment of the present disclosure provides a method for detecting encrypted content, and the method does not need to rely on a TLS proxy server. Therefore, detection complexity and detection costs can be reduced.

The method for detecting encrypted content in this embodiment of the present disclosure can be applied to a communications network, for example, a DCN or a wide area network (WAN). In this embodiment of the present disclosure, the communications network is, for example, a DCN. The method for detecting encrypted content according to this embodiment of the present disclosure is described in detail with reference to a system structure shown in FIG. 3.

As shown in FIG. 3, the system architecture includes a DCN 300 and a client 310. The DCN 300 includes a server 320, an SDN controller 330, a key manager 340, and a middlebox network device 350. There is a trust relationship between the server 320, the SDN controller 330, the key manager 340, and the middlebox network device 350. The SDN controller 330 and the key manager 340 are two logically separated components. The key manager 340 may be physically a part of the SDN controller 330, or may be a separate device. In this embodiment of the present disclosure, the method for detecting encrypted content according to this embodiment of the present disclosure is mainly described using the key manager 340 and the SDN controller 330 as two independent devices. It should be noted that when the key manager 340 and the SDN controller 330 are two independent devices, the key manager 340 and the SDN controller 330 are connected to each other, for example, connected using the Transmission Control Protocol (TCP) or using the User Datagram Protocol (UDP), and the SDN controller 330 and the middlebox network device 350 are connected to each other (for example, connected using the TCP or the UDP).

Further, in this embodiment of the present disclosure, the client 310 and the server 320 are two endpoints of a TLS session for accessing a service, and communicate with each other by establishing a TLS secure channel. The key manager 340 is responsible for managing and controlling TLS session parameters (for example, 5-tuple information) and key parameters (for example, a first random number, a second random number, a pre-master key, and a pseudo-random function or a session key) in a centralized manner. In addition, the DCN 300 may include a plurality of middlebox network devices 350, such as an FW, an IDS, and an IPS. The middlebox network device 350 is on the TLS secure channel. The middlebox network device 350 may obtain content (including plaintext in a handshake phase, encrypted content that is encrypted using a public key, and encrypted content obtained after the handshake phase is completed) of communication between the client 310 and the server 320, and is responsible for detecting the encrypted content. The SDN controller 330 provides device information for the key manager 340, to be specific, notifies the key manager 340 of middlebox network devices 350 on the TLS secure channel that need to detect the encrypted content. A first secure channel is established between the key manager 340 and each middlebox network device 350 that needs to detect the encrypted content, for transmission of the TLS session parameters, the key parameters, and the like between the key manager 340 and the middlebox network device 350. The first secure channel may be a TLS secure channel, a Datagram TLS (DTLS) secure channel, or the like. A second secure channel is established between the key manager 340 and the server 320, for transmission of the TLS session parameters, the key parameters, and the like between the key manager 340 and the server 320. The second secure channel may be a TLS secure channel, a DTLS secure channel, or the like.

It should be understood that, for processes of establishing the first secure channel and the second secure channel, refer to the method shown in FIG. 2. For brevity, details are not described herein again.

It should be further understood that, in this embodiment of the present disclosure, numbers such as “first” and “second” are merely intended to distinguish between different objects, for example, to distinguish between secure channels established between different devices, and do not impose any limitation on the protection scope of this embodiment of the present disclosure.

It should be noted that detection of the encrypted content described in this embodiment of the present disclosure means decrypting encrypted application data and detecting decrypted application data.

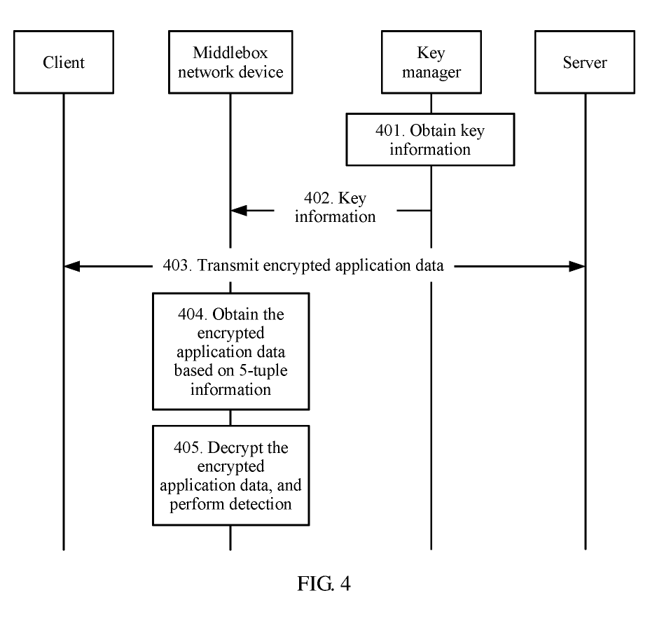

The method for detecting encrypted content according to this embodiment of the present disclosure is described in detail below with reference to FIG. 3 and FIG. 4. It should be understood that execution bodies in FIG. 4 may be separately corresponding to the devices shown in FIG. 3.

In this embodiment of the present disclosure, there may be a plurality of middlebox network devices that need to detect encrypted content of the encrypted application data transmitted over the TLS secure channel. For example, an IPS, an IDS, and a DDoS all need to detect the encrypted content. In FIG. 4, only one middlebox network device is used as an example for description. For another middlebox network device that needs to detect the encrypted content of the encrypted application data transmitted over the TLS secure channel, refer to descriptions of the middlebox network device shown in FIG. 4. Details are not described below.

Step 401. A key manager obtains key information of a TLS secure channel.

It should be understood that the TLS secure channel may be the TLS secure channel shown in FIG. 3.

Optionally, the key information may include a first random number, a second random number, a pre-master key, and a pseudo-random function. For detailed descriptions of the first random number, the pre-master key, and the second random number, refer to an existing protocol or the foregoing descriptions of FIG. 2. For brevity, details are not described herein again.

Optionally, the key information may include a session key.

For the session key, refer to an existing protocol or the foregoing descriptions of FIG. 2. For brevity, details are not described herein again.

In this embodiment of the present disclosure, the key information may be sent by a server to the key manager, or may be pre-stored by the key manager.

For example, when one of the middlebox network devices needs to detect the encrypted content of the encrypted application data transmitted over the TLS secure channel, the key manager may obtain the key information of the TLS secure channel from the server, and send the obtained key information to the middlebox network device. In addition, the key manager may locally store the key information of the TLS secure channel. In this case, when another middlebox network device also needs to detect the encrypted content of the encrypted application data transmitted over the TLS secure channel, the key manager may directly send the previously stored key information of the TLS secure channel to the middlebox network device, with no need to request the server for the key information of the TLS secure channel.

Optionally, if the key information is sent by the server to the key manager, before the server sends the key information to the key manager, the method may further include sending, by the server, a detection query message to a client using the TLS secure channel, where the detection query message is used to determine whether the client allows the middlebox network device to detect encrypted content of the encrypted application data, and receiving, by the server, a detection allowed message that is fed back on the detection query message and that is sent by the client, where the detection allowed message is used to indicate that the client allows the middlebox network device to detect the encrypted content of the encrypted application data.

Further, the server first queries whether the client allows the middlebox network device to detect the encrypted content of the encrypted application data. The server can send the key information to the key manager only if the client allows the middlebox network device to detect the encrypted content of the encrypted application data. If the client does not allow the middlebox network device to detect the encrypted application data, the server does not send the key information to the key manager, or notifies the key manager that the server cannot provide the key information for the key manager.

Step 402. The key manager sends the key information to a middlebox network device using a first secure channel.

It should be understood that the first secure channel may be the first secure channel shown in FIG. 3.

Step 403. A client and a server transmit encrypted application data to each other over the TLS secure channel.

When the client and the server transmit application data to each other over the TLS secure channel, a transmit end encrypts the application data using the session key, to generate and transmit the encrypted application data.

Step 404. The middlebox network device obtains the encrypted application data based on 5-tuple information of the TLS secure channel.

In an establishment process of the TLS secure channel, the middlebox network device may obtain the 5-tuple information of the TLS secure channel. The 5-tuple information uniquely determines the TLS secure channel. The 5-tuple information includes an IP address of the client, a port number of the client, an IP address of the server, a port number of the server, and a transport layer protocol. The middlebox network device can obtain, using the 5-tuple information, the encrypted application data transmitted over the TLS secure channel.

Step 405. The middlebox network device decrypts the encrypted application data using a session key corresponding to the key information, and detects decrypted application data.

In this embodiment of the present disclosure, in a first case, the key information sent by the key manager to the middlebox network device includes the first random number, the second random number, the pre-master key, and the pseudo-random function. In this case, before step 403, the middlebox network device may generate the session key based on the first random number, the second random number, the pre-master key, and the pseudo-random function that are sent by the key manager. Further, the middlebox network device may use, as three independent variables of the pseudo-random function, the first random number, the second random number, and the pre-master key that are sent by the key manager, to compute the session key. In this way, when the client and the server transmit the encrypted application data to each other over the TLS secure channel, after obtaining the encrypted application data based on the 5-tuple information, the middlebox network device may decrypt the encrypted application data using the session key previously obtained through computation, and detect the decrypted application data. In this case, the session key corresponding to the key information is a session key generated based on the first random number, the second random number, the pre-master key, and the pseudo-random function that are included in the key information.

For the first case, the first random number, the second random number, the pre-master key, and the pseudo-random function that are sent by the key manager to the middlebox network device may be received from the server.

In this embodiment of the present disclosure, in a second case, the key information sent by the key manager to the middlebox network device includes a session key. In this case, the session key corresponding to the key information is the session key included in the key information, and after obtaining the encrypted application data based on the 5-tuple information, the middlebox network device may directly decrypt the encrypted application data using the session key, and detect the decrypted application data.

For the second case, the session key sent by the key manager to the middlebox network device may be received from the server, or may be generated based on the first random number, the second random number, the pre-master key, and the pseudo-random function that are received from the server.

In the foregoing two cases, if it is detected that the decrypted application data poses no threat to a DCN, for example, the decrypted application data has no virus, Trojan horse, or the like, the decrypted application data is received and sent normally. If the decrypted application data poses a threat to the DCN, the DCN may control to stop transmission of the encrypted application data before the encrypted application data arrives at the server, or if the encrypted application data has arrived at the server, the DCN may control not to transmit application data to be transmitted subsequently.

Therefore, in the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

The method for detecting encrypted content according to this embodiment of the present disclosure is described in detail below with reference to specific embodiments.

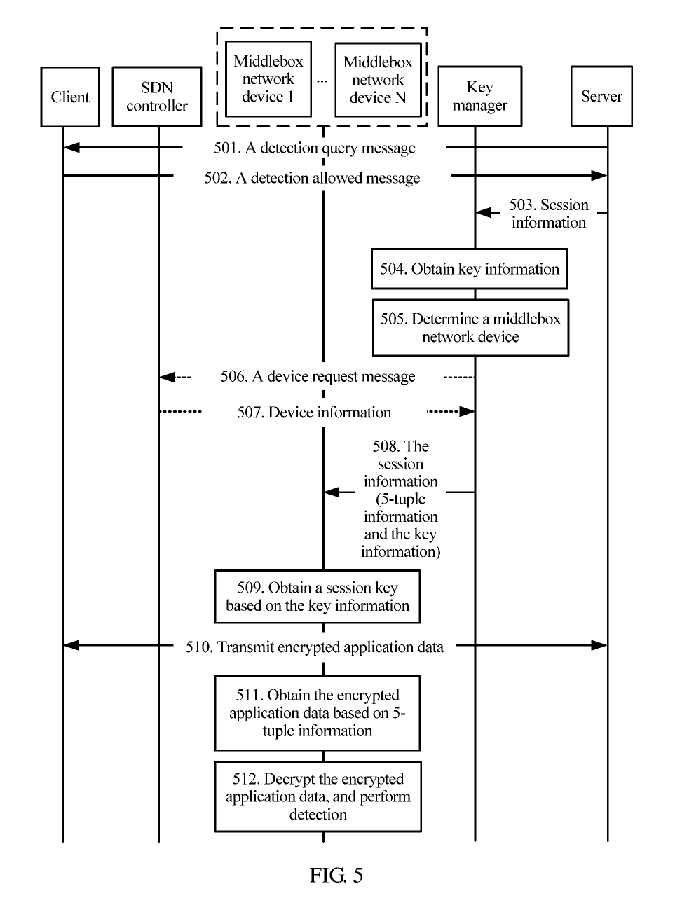

FIG. 5 is a schematic flowchart of a method for detecting encrypted content according to an embodiment of the present disclosure. It should be understood that a middlebox network device 1 to a middlebox network device N shown in FIG. 5 are N middlebox network devices that need to detect encrypted content of encrypted application data transmitted over a TLS secure channel. During specific implementation, there may be one or more middlebox network devices that need to detect encrypted content of encrypted application data transmitted over a TLS secure channel.

Step 501. A server sends a detection query message to a client.

The server sends the detection query message to the client using the TLS secure channel, to determine whether the client allows the middlebox network device to detect the encrypted content of the encrypted application data. The encrypted application data is generated by the client or the server by encrypting application data based on a session key.

It should be understood that the TLS secure channel may be the second secure channel shown in FIG. 3.

Step 502. The client sends a detection allowed message to the server.

After receiving the detection query message, if the client allows the middlebox network device to detect the encrypted content of the encrypted application data, the client returns the detection allowed message.

Step 503. The server sends session information to a key manager.

If the client allows the middlebox network device to detect the encrypted content of the encrypted application data, the server may actively provide the session information for the key manager using the second secure channel. Alternatively, before sending the session information to the key manager, the server may directly send the session information to the key manager without querying the client.

The session information may include key information and 5-tuple information. Further, for specific content of the key information and the 5-tuple information, refer to descriptions of the key information in step 401 and descriptions of the 5-tuple information in step 404, respectively. For brevity, details are not described herein again.

Step 504. The key manager obtains key information.

Further, after receiving the session information, the key manager may obtain the key information in the session information.

Step 505. The key manager determines a middlebox network device based on 5-tuple information.

Further, the key manager determines the middlebox network device that is on the TLS secure channel identified by the 5-tuple information.

In this embodiment of the present disclosure, the key manager may be a module of an SDN controller, or may be a device independent of the SDN controller.

The SDN controller is configured to control a path used for data transmission between the client and the server. A forwarding device receives, on a forwarding path controlled by the SDN controller, a first packet in a handshake phase of the client and the server, and reports the packet to the SDN controller such that the SDN controller can determine, based on information in the packet, that the packet belongs to the server, and can further determine a middlebox network device through which subsequent application data needs to pass and a middlebox network device that needs to detect encrypted content. In addition, the SDN controller stores a mapping relationship between 5-tuple information and a middlebox network device. The mapping relationship indicates a correspondence between 5-tuple information and a middlebox network device that detects encrypted content.

When the key manager is a module of the SDN controller, the key manager can directly determine the middlebox network device.

Optionally, when the key manager and the SDN controller are two independent devices, the key manager may further determine the middlebox network device using the following steps.

Step 506. The key manager sends a device request message to an SDN controller, where the device request message includes the 5-tuple information, and the device request message is used to request device information of the middlebox network device that is on the TLS secure channel identified by the 5-tuple information. The device information of the middlebox network device may include an IP address of the middlebox network device.

Step 507. The key manager receives the device information sent by the SDN controller based on the device request message.

Further, when the key manager and the SDN controller are two independent devices, the key manager sends the device request message to the SDN controller, to determine a middlebox network device that needs to detect the encrypted content of the encrypted application data. After receiving the device request message, the SDN controller may determine, based on the stored mapping relationship between 5-tuple information and a middlebox network device, the device information requested by the key manager. The SDN controller sends information to the key manager, and after receiving the information, the key manager may determine N middlebox network devices based on the device information.

Step 508. The key manager sends the session information to the middlebox network device.

The key manager sends the session information to the N middlebox network devices using N first secure channels, and notifies the N middlebox network devices of the 5-tuple information and the key information provided by the server.

Step 509. The middlebox network device obtains a session key based on the key information.

For example, when the key information in the session information includes the first random number, the second random number, the pre-master key, and the pseudo-random function, the key manager uses the first random number, the second random number, and the pre-master key as three independent variables of the pseudo-random function, and obtains the session key through computation. Alternatively, the key manager directly extracts the session key from the session information.

Step 510. The client and the server transmit encrypted application data to each other over a TLS secure channel.

Step 511. The middlebox network device obtains the encrypted application data based on the 5-tuple information.

Step 512. The middlebox network device decrypts the encrypted application data using the session key, and detects decrypted application data.

In this embodiment of the present disclosure, for steps 510 to 512, refer to steps 403 to 405 in the method shown in FIG. 4. For brevity, details are not described herein again.

In the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

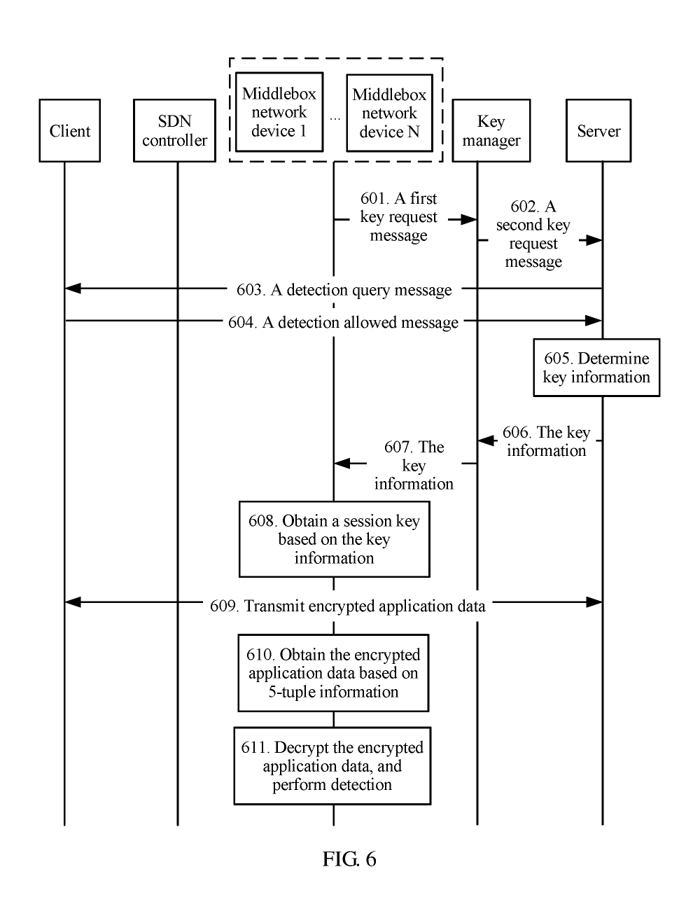

FIG. 6 is a schematic flowchart of a method for detecting encrypted content according to another embodiment of the present disclosure.

It should be understood that a middlebox network device 1 to a middlebox network device N shown in FIG. 6 are N middlebox network devices that need to detect encrypted content of encrypted application data transmitted over a TLS secure channel. During specific implementation, there may be one or more middlebox network devices that need to detect encrypted content of encrypted application data transmitted over a TLS secure channel.

Step 601. A middlebox network device sends a first key request message to a key manager.

The key request message includes 5-tuple information of the TLS secure channel. For specific content of the 5-tuple information, refer to descriptions of the 5-tuple information in step 404 in the method shown in FIG. 4. For brevity, details are not described herein again.

In a plaintext phase of a handshake phase between a client and a server, the middlebox network device may detect that a TLS secure channel is being established between the client and the server, and the middlebox network device may obtain the 5-tuple information. After obtaining the 5-tuple information, the middlebox network device may add the 5-tuple information to the first key request message. The middlebox network device can request key information by sending the first key request message to the key manager, to obtain a session key. After receiving the first key request message, the key manager checks whether the key manager stores key information corresponding to the 5-tuple information. If the key manager has stored the key information, the key manager may perform step 607, to be specific, sends the key information to the middlebox network device. If the key manager does not store the key information, the key manager may perform step 602.

Step 602. The key manager sends a second key request message to a server.

The second key request message includes the 5-tuple information. The key manager sends the second key request message to the server using a second secure channel, to request the key information.

Step 603. The server sends a detection query message to a client.

After receiving the second key request message sent by the key manager, the server may send the detection query message to the client, to query whether the client allows the middlebox network device to detect encrypted content of the encrypted application data. The encrypted application data is generated by the client or the server by encrypting application data based on the session key.

Alternatively, after receiving the key request message sent by the key manager, the server may directly perform step 605 without querying the client.

Step 604. The client sends a detection allowed message to the server.

After receiving the detection query message, if the client allows the middlebox network device to detect the encrypted content of the encrypted application data, the client returns the detection allowed message.

Step 605. The server determines key information.

Further, the server may determine, based on the 5-tuple information in the second key request message, the key information required by the key manager. The key information is obtained by the server in a handshake phase of establishing the TLS secure channel.

For the key information, refer to the foregoing descriptions of the key information in step 401 in the method shown in FIG. 4. For brevity, details are not described herein again.

Step 606. The server sends the key information to the key manager using a second secure channel.

It should be noted that the server may further send the 5-tuple information to the key manager. Further, the server may add the key information and the 5-tuple information to a same message (for example, a response message corresponding to the second key request message), and send the message to the key manager. Accordingly, after receiving the message, the key manager can learn that the key information carried in the message is the key information corresponding to the 5-tuple information.

Alternatively, the server may not send the 5-tuple information to the key manager. The server may further send the key information using a response message corresponding to the second key request message. Accordingly, the key manager may determine, based on a correspondence between the second key request message and the response message, that the key information is the key information corresponding to the 5-tuple information included in the second key request message.

Step 607. The key manager sends the key information to the middlebox network device.

The key manager sends the received key information to the middlebox network device using a first secure channel.

It should be noted that the key manager may further send the 5-tuple information to the middlebox network device. Further, the key manager may add the key information and the 5-tuple information to a same message (for example, a response message corresponding to the first key request message), and send the message to the middlebox network device. Accordingly, after receiving the message, the middlebox network device can learn that the key information carried in the message is the key information corresponding to the 5-tuple information.

Alternatively, the key manager may not send the 5-tuple information to the middlebox network device. The key manager may further send the key information using a response message corresponding to the first key request message. Accordingly, the middlebox network device may determine, based on a correspondence between the first key request message and the response message, that the key information is the key information corresponding to the 5-tuple information included in the first key request message.

Step 608. The middlebox network device obtains a session key based on the key information.

For example, when the key information includes a first random number, a second random number, a pre-master key, and a pseudo-random function, the key manager uses the first random number, the second random number, and the pre-master key as three independent variables of the pseudo-random function, and obtains the session key through computation. Alternatively, the key manager directly extracts the session key from the session information.

Step 609. The client and the server transmit encrypted application data to each other over a TLS secure channel.

Step 610. The middlebox network device obtains the encrypted application data based on the 5-tuple information.

Step 611. The middlebox network device decrypts the encrypted application data using the session key, and detects decrypted application data.

In this embodiment of the present disclosure, for steps 609 to 611, refer to steps 403 to 405 in the method shown in FIG. 4. For brevity, details are not described herein again.

In the method for detecting encrypted content in this embodiment of the present disclosure, the middlebox network device decrypts the encrypted application data, and detects the decrypted application data. In this way, detection of encrypted content does not rely on a TLS proxy server, and detection complexity and detection costs can be reduced.

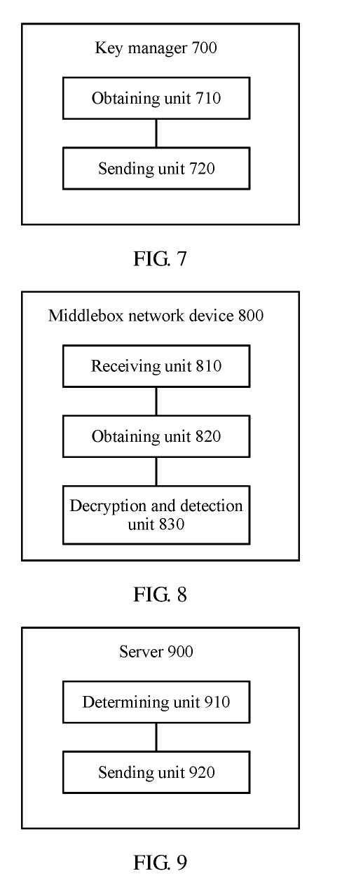

The methods for detecting encrypted content according to the embodiments of the present disclosure are described in detail above with reference to FIG. 1 to FIG. 6. A key manager, a middlebox network device, and a server according to the embodiments of the present disclosure are described below with reference to FIG. 7 to FIG. 9.

FIG. 7 is a schematic block diagram of a key manager 700 according to an embodiment of the present disclosure. As shown in FIG. 7, the key manager 700 includes an obtaining unit 710 and a sending unit 720.

The obtaining unit 710 is configured to obtain key information of a TLS secure channel, where the TLS secure channel is a secure channel established between a client and a server.

The sending unit 720 is configured to send, to a middlebox network device using a first secure channel, the key information obtained by the obtaining unit 710 such that the middlebox network device decrypts, using a session key corresponding to the key information, encrypted application data transmitted over the TLS secure channel, and detects decrypted application data. The encrypted application data is generated by the client or the server by encrypting application data based on the session key, the middlebox network device is located on the TLS secure channel, and the first secure channel is a secure channel established between the key manager and the middlebox network device.

The units of the key manager 700 in this embodiment of the present disclosure and the foregoing other operations or functions are respectively to implement corresponding procedures executed by the key manager in the methods shown in FIG. 4 to FIG. 6. For brevity, details are not described herein again.

Therefore, the key manager in this embodiment of the present disclosure provides the key information for the middlebox network device such that the middlebox network device can decrypt the encrypted application data using the session key corresponding to the key information, and detect the decrypted application data. In this way, detection of encrypted content does not rely on a TLS proxy server, and detection complexity and detection costs can be reduced.

FIG. 8 is a schematic block diagram of a middlebox network device 800 according to an embodiment of the present disclosure. As shown in FIG. 8, the middlebox network device 800 includes a receiving unit 810, an obtaining unit 820, and a decryption and detection unit 830.

The receiving unit 810 is configured to receive, using a first secure channel, key information that is of the TLS secure channel and that is sent by a key manager, and the first secure channel is a secure channel established between the middlebox network device and the key manager.

The obtaining unit 820 is configured to obtain, based on 5-tuple information of the TLS secure channel, encrypted application data transmitted over the TLS secure channel. The 5-tuple information includes an IP address of the client, a port number of the client, an IP address of the server, a port number of the server, and a transport layer protocol, and the encrypted application data is generated by the client or the server by encrypting application data based on a session key corresponding to the key information.

The decryption and detection unit 830 is configured to decrypt the encrypted application data using the session key, and detect decrypted application data.

The units of the middlebox network device 800 in this embodiment of the present disclosure and the foregoing other operations or functions are respectively to implement corresponding procedures executed by the middlebox network device in the methods shown in FIG. 4 to FIG. 6. For brevity, details are not described herein again.

Therefore, the middlebox network device in this embodiment of the present disclosure decrypts the encrypted application data, and detects the decrypted application data. In this way, detection of encrypted content does not rely on a TLS proxy server, and detection complexity and detection costs can be reduced.

FIG. 9 is a schematic block diagram of a server 900 according to an embodiment of the present disclosure. As shown in FIG. 9, the server 900 includes a determining unit 910 and a sending unit 920.

The determining unit 910 is configured to determine key information of a TLS secure channel established between a client and the server.

The sending unit 920 is configured to send, to a key manager using a second secure channel, the key information determined by the determining unit 910 such that the key manager sends, using a first secure channel, the key information to a middlebox network device located on the TLS secure channel, and the middlebox network device decrypts, using a session key corresponding to the key information, encrypted application data transmitted over the TLS secure channel, and detects decrypted application data. The encrypted application data is generated by the client or the server by encrypting application data based on the session key, the first secure channel is a secure channel established between the key manager and the middlebox network device, and the second secure channel is a secure channel established between the key manager and the server.

The units of the server 900 in this embodiment of the present disclosure and the foregoing other operations or functions are respectively to implement corresponding procedures executed by the server in the methods shown in FIG. 4 to FIG. 6. For brevity, details are not described herein again.

Therefore, the server 900 in this embodiment of the present disclosure provides the key information for the middlebox network device by providing the key information for the key manager such that the middlebox network device can decrypt the encrypted application data using the session key corresponding to the key information, and detect the decrypted application data. In this way, detection of encrypted content does not rely on a TLS proxy server, and detection complexity and detection costs can be reduced.

An embodiment of the present disclosure further provides a client, and the client includes a receiving unit and a sending unit.

The receiving unit is configured to receive a detection query message that is sent using a TLS secure channel established between the client and a server. The detection query message is used to determine whether the client allows a middlebox network device to detect encrypted content of encrypted application data, and the encrypted application data is generated by the client or the server by encrypting application data based on a session key of the TLS secure channel.

The sending unit is configured to send, when the client allows the middlebox network device to detect the encrypted content of the encrypted application data, a detection allowed message to the server using the TLS secure channel.

In this embodiment of the present disclosure, when the client allows the middlebox network device to detect encrypted content transmitted between the client and the server, the encrypted content is detected such that a security risk can be reduced.

An embodiment of the present disclosure further provides an SDN controller, and the SDN controller includes a receiving unit, a determining unit, and a sending unit.

The receiving unit is configured to receive a device request message sent by a key manager. The device request message includes 5-tuple information of a TLS secure channel established between a client and a server, and the 5-tuple information includes an IP address of the client, a port number of the client, an IP address of the server, a port number of the server, and a transport layer protocol.

The determining unit is configured to determine, based on the device request message, device information of a middlebox network device that is on the TLS secure channel identified by the 5-tuple information.

The sending unit is configured to send the device information to the key manager such that the key manager sends the 5-tuple information and key information of the TLS secure channel to the middlebox network device based on the device information of the middlebox network device using a first secure channel, and the middlebox network device obtains, based on the 5-tuple information, encrypted application data transmitted between the client and the server using the TLS secure channel, decrypts the encrypted application data using a session key corresponding to the key information, and detects decrypted application data. The encrypted application data is generated by the client or the server by encrypting application data based on the session key, and the first secure channel is a secure channel established between the middlebox network device and the key manager.

Therefore, the middlebox network device determined by the SDN controller in this embodiment of the present disclosure decrypts the encrypted application data, and detects the decrypted application data. In this way, detection of encrypted content does not rely on a TLS proxy server, and detection complexity and detection costs can be reduced.

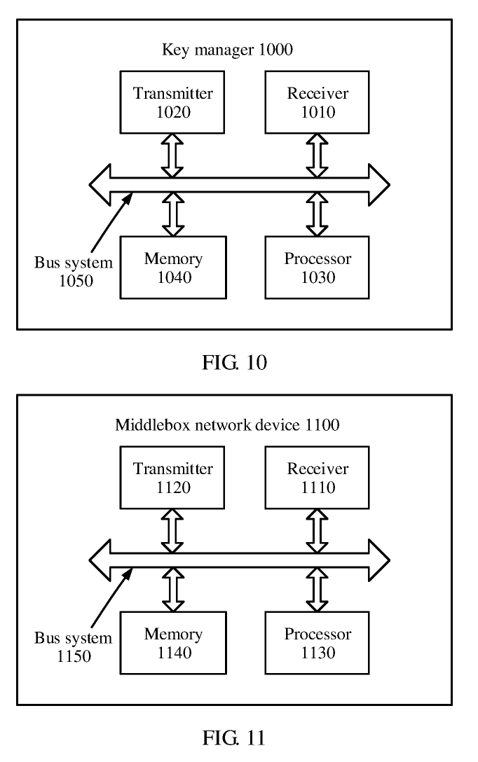

The methods for detecting encrypted content according to the embodiments of the present disclosure are described in detail above with reference to FIG. 1 to FIG. 6. A key manager, a middlebox network device, and a server according to the embodiments of the present disclosure are described below with reference to FIG. 10 to FIG. 12.

FIG. 10 is a schematic block diagram of a key manager 1000 according to an embodiment of the present disclosure. As shown in FIG. 10, the key manager 1000 includes a receiver 1010, a transmitter 1020, a processor 1030, a memory 1040, and a bus system 1050. The receiver 1010, the transmitter 1020, the processor 1030, and the memory 1040 are connected using the bus system 1050. The memory 1040 is configured to store an instruction. The processor 1030 is configured to execute the instruction stored in the memory 1040, to control the receiver 1010 to receive a signal and control the transmitter 1020 to send a signal.

The processor 1030 is configured to obtain key information of a TLS secure channel, where the TLS secure channel is a secure channel established between a client and a server.

The transmitter 1020 is configured to send, to a middlebox network device using a first secure channel, the key information obtained by the processor 1030 such that the middlebox network device decrypts, using a session key corresponding to the key information, encrypted application data transmitted over the TLS secure channel, and detects decrypted application data. The encrypted application data is generated by the client or the server by encrypting application data based on the session key, the middlebox network device is located on the TLS secure channel, and the first secure channel is a secure channel established between the key manager and the middlebox network device.

It should be understood that in this embodiment of the present disclosure, the processor 1030 may be a central processing unit (CPU), or the processor 1030 may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor, or the processor 1030 may be any conventional processor or the like.

The memory 1040 may include a read-only memory (ROM) and a random access memory (RAM), and provides an instruction and data for the processor 1030. A part of the memory 1040 may further include a nonvolatile RAM (NVRAM). For example, the memory 1040 may further store information about a mapping relationship between 5-tuple information and key information.

In addition to a data bus, the bus system 1050 may include a power bus, a control bus, a status signal bus, and the like. However, for clarity of description, various buses are marked as the bus system 1050 in the figure.

In an implementation process, steps in the foregoing method may be completed using an integrated logic circuit of hardware in the processor 1030 or an instruction in a form of software. Steps of the method for detecting encrypted content disclosed with reference to the embodiments of the present disclosure may be directly executed and completed by a hardware processor, or may be executed and completed using a combination of hardware and software modules in the processor. The software module may be located in a mature storage medium in the field, such as a RAM, a flash memory, a ROM, a programmable ROM (PROM), an electrically-erasable PROM (EEPROM), or a register. The storage medium is located in the memory 1040. The processor 1030 reads information in the memory 1040, and completes the steps of the foregoing method in combination with hardware of the processor. To avoid repetition, details are not described herein.

The units of the key manager 1000 in this embodiment of the present disclosure and the foregoing other operations or functions are respectively to implement corresponding procedures executed by the key manager in the methods shown in FIG. 4 to FIG. 6. For brevity, details are not described herein again.

Therefore, the key manager 1000 in this embodiment of the present disclosure provides the key information for the middlebox network device such that the middlebox network device can decrypt the encrypted application data using the session key corresponding to the key information, and detect decrypted content. In this way, detection of encrypted content does not rely on a TLS proxy server, and detection complexity and detection costs can be reduced.

FIG. 11 is a schematic block diagram of a middlebox network device 1100 according to an embodiment of the present disclosure. As shown in FIG. 11, the middlebox network device 1100 includes a receiver 1110, a transmitter 1120, a processor 1130, a memory 1140, and a bus system 1150. The receiver 1110, the transmitter 1120, the processor 1130, and the memory 1140 are connected using the bus system 1150. The memory 1140 is configured to store an instruction. The processor 1130 is configured to execute the instruction stored in the memory 1140, to control the receiver 1110 to receive a signal and control the transmitter 1120 to send a signal.

The receiver 1110 is configured to receive, using a first secure channel, key information that is of the TLS secure channel and that is sent by a key manager, and the first secure channel is a secure channel established between the middlebox network device and the key manager.

The processor 1130 is configured to obtain, based on 5-tuple information of the TLS secure channel, encrypted application data transmitted over the TLS secure channel. The 5-tuple information includes an IP address of the client, a port number of the client, an IP address of the server, a port number of the server, and a transport layer protocol, and the encrypted application data is generated by the client or the server by encrypting application data based on a session key corresponding to the key information.

The processor 1130 is further configured to decrypt the encrypted application data using the session key, and detect decrypted application data.

It should be understood that in this embodiment of the present disclosure, the processor 1130 may be a CPU, or the processor 1130 may be another general purpose processor, a DSP, an ASIC, an FPGA or another programmable logic device, a discrete gate or a transistor logic device, a discrete hardware component, or the like. The general purpose processor may be a microprocessor, or the processor 1130 may be any conventional processor or the like.

The memory 1140 may include a ROM and a RAM, and provides an instruction and data for the processor 1130. A part of the memory 1140 may further include an NVRAM.

In addition to a data bus, the bus system 1150 may include a power bus, a control bus, a status signal bus, and the like. However, for clarity of description, various buses are marked as the bus system 1150 in the figure.

In an implementation process, steps in the foregoing method may be completed using an integrated logic circuit of hardware in the processor 1130 or an instruction in a form of software. Steps of the method for detecting encrypted content disclosed with reference to the embodiments of the present disclosure may be directly executed and completed by a hardware processor, or may be executed and completed using a combination of hardware and software modules in the processor. The software module may be located in a mature storage medium in the field, such as a RAM, a flash memory, a ROM, a PROM, an EEPROM, or a register. The storage medium is located in the memory 1140. The processor 1130 reads information in the memory 1140, and completes the steps of the foregoing method in combination with hardware of the processor 1130. To avoid repetition, details are not described herein.

The units of the middlebox network device 1100 in this embodiment of the present disclosure and the foregoing other operations or functions are respectively to implement corresponding procedures executed by the middlebox network device in the methods shown in FIG. 4 to FIG. 6. For brevity, details are not described herein again.

Therefore, the middlebox network device 1100 in this embodiment of the present disclosure decrypts the encrypted application data, and detects decrypted content. In this way, detection of encrypted content does not rely on a TLS proxy server, and detection complexity and detection costs can be reduced.

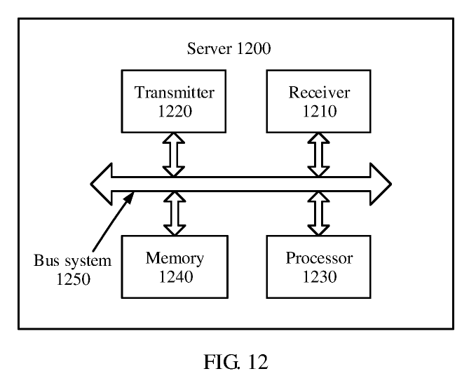

FIG. 12 is a schematic block diagram of a server 1200 according to an embodiment of the present disclosure. As shown in FIG. 12, the server 1200 includes a receiver 1210, a transmitter 1220, a processor 1230, a memory 1240, and a bus system 1250. The receiver 1210, the transmitter 1220, the processor 1230, and the memory 1240 are connected using the bus system 1250. The memory 1240 is configured to store an instruction. The processor 1230 is configured to execute the instruction stored in the memory 1240, to control the receiver 1210 to receive a signal and control the transmitter 1220 to send a signal.

The processor 1230 is configured to determine key information of a TLS secure channel established between a client and the server.

The transmitter 1220 is configured to send, to a key manager using a second secure channel, the key information determined by the processor 1230 such that the key manager sends, using a first secure channel, the key information to a middlebox network device located on the TLS secure channel, and the middlebox network device decrypts, using a session key corresponding to the key information, encrypted application data transmitted over the TLS secure channel, and detects decrypted application data. The encrypted application data is generated by the client or the server by encrypting application data based on the session key, the first secure channel is a secure channel established between the key manager and the middlebox network device, and the second secure channel is a secure channel established between the key manager and the server.

It should be understood that in this embodiment of the present disclosure, the processor 1230 may be a CPU, or the processor 1230 may be another general purpose processor, a DSP, an ASIC, an FPGA or another programmable logic device, a discrete gate or a transistor logic device, a discrete hardware component, or the like. The general purpose processor may be a microprocessor, or the processor 1230 may be any conventional processor or the like.

The memory 1240 may include a ROM and a RAM, and provides an instruction and data for the processor 1230. A part of the memory 1240 may further include an NVRAM.

In addition to a data bus, the bus system 1250 may include a power bus, a control bus, a status signal bus, and the like. However, for clarity of description, various buses are marked as the bus system 1250 in the figure.

In an implementation process, steps in the foregoing method may be completed using an integrated logic circuit of hardware in the processor 1230 or an instruction in a form of software. Steps of the method for detecting encrypted content disclosed with reference to the embodiments of the present disclosure may be directly executed and completed by a hardware processor, or may be executed and completed using a combination of hardware and software modules in the processor. The software module may be located in a mature storage medium in the field, such as a RAM, a flash memory, a ROM, a PROM, an EEPROM, or a register. The storage medium is located in the memory 1240. The processor 1230 reads information in the memory 1240, and completes the steps of the foregoing method in combination with hardware of the processor. To avoid repetition, details are not described herein.

The units of the server 1200 in this embodiment of the present disclosure and the foregoing other operations or functions are respectively to implement corresponding procedures executed by the server in the methods shown in FIG. 4 to FIG. 6. For brevity, details are not described herein again.

Therefore, the server 1200 in this embodiment of the present disclosure provides the key information for the middlebox network device by providing the key information for the key manager such that the middlebox network device can decrypt the encrypted application data using the session key corresponding to the key information, and detect decrypted content. In this way, detection of encrypted content does not rely on a TLS proxy server, and detection complexity and detection costs can be reduced.

An embodiment of the present disclosure further provides a client, and the client includes a receiver, a transmitter, a processor, a memory, and a bus system. The receiver, the transmitter, the processor, and the memory are connected using the bus system. The memory is configured to store an instruction. The processor is configured to execute the instruction stored in the memory, to control the receiver to receive a signal and control the transmitter to send a signal.

The receiver is configured to receive a detection query message that is sent using a TLS secure channel established between the client and a server. The detection query message is used to determine whether the client allows a middlebox network device to detect encrypted content of encrypted application data, and the encrypted application data is generated by the client or the server by encrypting application data based on a session key of the TLS secure channel.

The transmitter is configured to send, when the client allows the middlebox network device to detect the encrypted content of the encrypted application data, a detection allowed message to the server using the TLS secure channel.

It should be understood that in this embodiment of the present disclosure, the processor may be a CPU, or the processor may be another general purpose processor, a DSP, an ASIC, an FPGA or another programmable logic device, a discrete gate or a transistor logic device, a discrete hardware component, or the like. The general purpose processor may be a microprocessor, or the processor may be any conventional processor or the like.

The memory may include a ROM and a RAM, and provide an instruction and data for the processor. A part of the memory may further include a nonvolatile random access memory.

In addition to a data bus, the bus system may include a power bus, a control bus, a status signal bus, and the like. However, for clarity of description, various buses are marked as the bus system in the figure.

In an implementation process, steps in the foregoing method may be completed using an integrated logic circuit of hardware in the processor or an instruction in a form of software. Steps of the method for detecting encrypted content disclosed with reference to the embodiments of the present disclosure may be directly executed and completed by a hardware processor, or may be executed and completed using a combination of hardware and software modules in the processor. The software module may be located in a mature storage medium in the field, such as a RAM, a flash memory, a ROM, a PROM, an EEPROM, or a register. The storage medium is located in the memory, and the processor reads information in the memory and completes the steps in the foregoing method in combination with the hardware in the processor. To avoid repetition, details are not described herein.

The units of the client in this embodiment of the present disclosure and the foregoing other operations or functions are respectively to implement corresponding procedures executed by the client in the methods shown in FIG. 4 to FIG. 6. For brevity, details are not described herein again.

When the client allows the middlebox network device to detect encrypted content transmitted between the client and the server, the encrypted content is detected such that a security risk can be reduced.

An embodiment of the present disclosure further provides an SDN controller, and the SDN controller includes a receiver, a transmitter, a processor, a memory, and a bus system. The receiver, the transmitter, the processor, and the memory are connected using the bus system. The memory is configured to store an instruction. The processor is configured to execute the instruction stored in the memory, to control the receiver to receive a signal and control the transmitter to send a signal.

The receiver is configured to receive a device request message sent by a key manager. The device request message includes 5-tuple information of a TLS secure channel established between a client and a server, the 5-tuple information includes an IP address of the client, a port number of the client, an IP address of the server, a port number of the server, and a transport layer protocol, and the device request message is used to request device information of a middlebox network device that is on the TLS secure channel identified by the 5-tuple information.

The processor is configured to determine, based on the device request message, the device information of the middlebox network device that is on the TLS secure channel identified by the 5-tuple information.

The transmitter is configured to send the device information to the key manager such that the key manager sends the 5-tuple information and key information of the TLS secure channel to the middlebox network device based on the device information of the middlebox network device using a first secure channel, and the middlebox network device obtains, based on the 5-tuple information, encrypted application data transmitted between the client and the server using the TLS secure channel, decrypts the encrypted application data using a session key corresponding to the key information, and detects decrypted application data. The encrypted application data is generated by the client or the server by encrypting application data based on the session key, and the first secure channel is a secure channel established between the middlebox network device and the key manager.

It should be understood that in this embodiment of the present disclosure, the processor may be a CPU) or the processor may be another general purpose processor, a digital signal processor (DSP, an ASIC, an FPGA or another programmable logic device, a discrete gate or a transistor logic device, a discrete hardware component, or the like. The general purpose processor may be a microprocessor, or the processor may be any conventional processor or the like.

The memory may include a ROM and a RAM, and provide an instruction and data for the processor. A part of the memory may further include an NVRAM.

In addition to a data bus, the bus system may include a power bus, a control bus, a status signal bus, and the like. However, for clarity of description, various buses are marked as the bus system in the figure.

In an implementation process, steps in the foregoing method may be completed using an integrated logic circuit of hardware in the processor or an instruction in a form of software. Steps of the method for detecting encrypted content disclosed with reference to the embodiments of the present disclosure may be directly executed and completed by a hardware processor, or may be executed and completed using a combination of hardware and software modules in the processor. The software module may be located in a mature storage medium in the field, such as a RAM, a flash memory, a ROM, a PROM, an EEPROM, or a register. The storage medium is located in the memory, and the processor reads information in the memory and completes the steps in the foregoing method in combination with the hardware in the processor. To avoid repetition, details are not described herein again.

The units of the SDN controller in this embodiment of the present disclosure and the foregoing other operations or functions are respectively to implement corresponding procedures executed by the SDN controller in the methods shown in FIG. 4 to FIG. 6. For brevity, details are not described herein again.

Therefore, the middlebox network device determined by the SDN controller in this embodiment of the present disclosure decrypts the encrypted application data, and detects the decrypted application data. In this way, detection of encrypted content does not rely on a TLS proxy server, and detection complexity and detection costs can be reduced.

The term “and/or” in this specification describes only an association relationship for describing associated objects and represents that three relationships may exist. For example, A and/or B may represent the following three cases, only A exists, both A and B exist, and only B exists. In addition, the character “/” in this specification generally indicates an “or” relationship between the associated objects.

It should be understood that sequence numbers of the foregoing processes do not mean execution sequences in the embodiments of the present disclosure. The execution sequences of the processes should be determined based on functions and internal logic of the processes, and should not be construed as any limitation on the implementation processes of the embodiments of the present disclosure.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for convenience and conciseness of description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the other approaches, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for detecting encrypted content, the method being applied to a communications network, and the method comprising:
obtaining, by a key manager, key information of a Transport Layer Security (TLS) secure channel, the communications network comprising a middlebox network device, the key manager, and a server, and the middlebox network device being located on the TLS secure channel established between a client and the server; and
sending, by the key manager, the key information to the middlebox network device using a first secure channel to enable the middlebox network device to decrypt, using a session key corresponding to the key information, encrypted application data transmitted over the TLS secure channel and to detect decrypted application data, the encrypted application data being generated by the client or the server by encrypting application data based on the session key, and the first secure channel being a secure channel established between the key manager and the middlebox network device.

2. The method of claim 1, wherein before obtaining the key information of the TLS secure channel, the method further comprises receiving, by the key manager, a first key request message from the middlebox network device using the first secure channel, the first key request message comprising 5-tuple information of the TLS secure channel, the first key request message requesting the key information, the 5-tuple information comprising an Internet Protocol (IP) address of the client, a port number of the client, an IP address of the server, a port number of the server, and a transport layer protocol, and obtaining the key information of the TLS secure channel comprising obtaining, by the key manager, the key information based on the 5-tuple information.

3. The method of claim 2, wherein obtaining the the key information based on the 5-tuple information comprises:
sending, by the key manager, a second key request message to the server using a second secure channel, the second key request message comprising the 5-tuple information, and the second secure channel being a secure channel established between the key manager and the server; and
receiving, by the key manager, the key information from the server based on the second key request message.

4. The method of claim 1, wherein obtaining the key information of the TLS secure channel comprises:
receiving, by the key manager using a second secure channel, session information from the server, the session information comprising 5-tuple information of the TLS secure channel and the key information, the 5-tuple information comprising an Internet Protocol (IP) address of the client, a port number of the client, an IP address of the server, a port number of the server, and a transport layer protocol, and the second secure channel being a secure channel established between the key manager and the server; and
obtaining, by the key manager, the key information in the session information, and
the method further comprising:
determining, by the key manager, the middlebox network device on the TLS secure channel identified by the 5-tuple information before sending the key information to the middlebox network device using the first secure channel; and
sending, by the key manager, the 5-tuple information to the middlebox network device.

5. The method of claim 4, wherein the communications network further comprises a software-defined networking (SDN) controller coupled to the key manager and the middlebox network device, and determining the middlebox network device based on the 5-tuple information comprising:
sending, by the key manager, a device request message to the SDN controller, the device request message comprising the 5-tuple information, and the device request message requesting device information of the middlebox network device on the TLS secure channel identified by the 5-tuple information; and
receiving, by the key manager, the device information from the SDN controller based on the device request message.

6. The method of claim 1, wherein the key information comprises a first random number, a second random number, a pre-master key, and a pseudo-random function, the first random number and the pre-master key being random numbers generated by the client, the second random number being a random number generated by the server, and the pseudo-random function generating the session key based on the first random number, the second random number, and the pre-master key.

7. The method of claim 1, wherein the key information comprises the session key.

8. The method of claim 7, wherein obtaining the key information of the TLS secure channel comprises generating, by the key manager, the session key based on a first random number, a second random number, a pre-master key, and a pseudo-random function received from the server, the first random number and the pre-master key being random numbers generated by the client, the second random number being a random number generated by the server, and the pseudo-random function generating the session key based on the first random number, the second random number, and the pre-master key.

9. A method for detecting encrypted content, the method being applied to a communications network, and the method comprising:
receiving, by a middlebox network device using a first secure channel, key information of a Transport Layer Security (TLS) secure channel from a key manager, the communications network comprising the middlebox network device, the key manager, and a server, the middlebox network device being located on the TLS secure channel established between a client and the server, the first secure channel being a secure channel established between the middlebox network device and the key manager;
obtaining, by the middlebox network device based on 5-tuple information of the TLS secure channel, encrypted application data transmitted over the TLS secure channel, wherein the 5-tuple information comprising an Internet Protocol (IP) address of the client, a port number of the client, an IP address of the server, a port number of the server, and a transport layer protocol, and the encrypted application data being generated by the client or the server by encrypting application data based on a session key corresponding to the key information;
decrypting, by the middlebox network device, the encrypted application data using the session key; and
detecting, by the middlebox network device, decrypted application data.

10. The method of claim 9, wherein the key information comprises a first random number, a second random number, a pre-master key, and a pseudo-random function, the first random number and the pre-master key being random numbers generated by the client, the second random number being a random number generated by the server, the pseudo-random function generating the session key based on the first random number, the second random number, and the pre-master key, and before decrypting the encrypted application data using the session key, the method further comprising generating, by the middlebox network device, the session key based on the first random number, the second random number, the pre-master key, and the pseudo-random function.

11. The method of claim 9, wherein the key information comprises the session key.

12. The method of claim 9, wherein before receiving the key information of the TLS secure channel from the key manager, the method further comprises sending, by the middlebox network device, a key request message to the key manager using the first secure channel, the key request message comprising the 5-tuple information, the key request message requesting the key information, and receiving the key information of the TLS secure channel from the key manager comprising receiving, by the middlebox network device using the first secure channel, the key information from the key manager based on the key request message.

13. The method of claim 9, wherein before obtaining the encrypted application data transmitted over the TLS secure channel, the method further comprises receiving, by the middlebox network device using the first secure channel, the 5-tuple information from the key manager.

14. A key manager, comprising:
a transmitter; and
a processor coupled to the transmitter and configured to:
obtain key information of a Transport Layer Security (TLS) secure channel, the TLS secure channel being a secure channel established between a client and a server; and
send, using the transmitter, the key information to a middlebox network device using a first secure channel to enable the middlebox network device to decrypt, using a session key corresponding to the key information, encrypted application data transmitted over the TLS secure channel and to detect decrypted application data, the encrypted application data being generated by the client or the server by encrypting application data based on the session key, the middlebox network device being located on the TLS secure channel, and the first secure channel being a secure channel established between the key manager and the middlebox network device.

15. The key manager of claim 14, further comprising a receiver coupled to the processor, and before obtaining the key information of the TLS secure channel, the processor being further configured to receive, using the receiver, a first key request message from the middlebox network device using the first secure channel, the first key request message comprising 5-tuple information of the TLS secure channel, the first key request message requesting the key information, the 5-tuple information comprising an Internet Protocol (IP) address of the client, a port number of the client, an IP address of the server, a port number of the server, and a transport layer protocol, and in a manner of obtaining the key information of the TLS secure channel, the processor being further configured to obtain the key information based on the 5-tuple information.

16. The key manager of claim 15, wherein in a manner of obtaining the key information based on the 5-tuple information, the processor is further configured to:
send, using the transmitter, a second key request message to the server using a second secure channel, the second key request message comprising the 5-tuple information, and the second secure channel being a secure channel established between the key manager and the server; and
receive, using the receiver, the key information from the server based on the second key request message.

17. The key manager of claim 14, further comprising a receiver coupled to the processor, and in a manner of obtaining the key information of the TLS secure channel, the processor being further configured to:
receive, using the receiver, session information from the server using a second secure channel, the session information comprising 5-tuple information of the TLS secure channel and the key information, the 5-tuple information comprising an Internet Protocol (IP) address of the client, a port number of the client, an IP address of the server, a port number of the server, and a transport layer protocol, and the second secure channel being a secure channel established between the key manager and the server; and
obtain the key information in the session information, and
the processor being further configured to:
determine the middlebox network device on the TLS secure channel identified by the 5-tuple information; and
send, using the transmitter, the 5-tuple information to the middlebox network device.

18. A middlebox network device, located on a Transport Layer Security (TLS) secure channel established between a client and a server, and the middlebox network device comprising:
a receiver; and
a processor coupled to the receiver and configured to:
receive, using the receiver, key information of the TLS secure channel from the key manager using a first secure channel, the first secure channel being a secure channel established between the middlebox network device and the key manager;
obtain based on 5-tuple information of the TLS secure channel, encrypted application data transmitted over the TLS secure channel, the 5-tuple information comprises an Internet Protocol (IP) address of the client, a port number of the client, an IP address of the server, a port number of the server, and a transport layer protocol, and the encrypted application data being generated by the client or the server by encrypting application data based on a session key corresponding to the key information;
decrypting the encrypted application data using the session key; and
detecting decrypted application data.

19. The middlebox network device of claim 18, wherein the key information comprises a first random number, a second random number, a pre-master key, and a pseudo-random function, the first random number and the pre-master key being random numbers generated by the client, the second random number being a random number generated by the server, the pseudo-random function generating the session key based on the first random number, the second random number, and the pre-master key, and before decrypting the encrypted application data using the session key, the processor being further configured to generate the session key based on the first random number, the second random number, the pre-master key, and the pseudo-random function.

20. The middlebox network device of claim 18, wherein the key information comprises the session key.
